(19) United States
(12) Patent Application Publication
(10) Pub. No.: US 2021/0066011 A1
(43) Pub. Date: Mar. 4, 2021

(54) Device for Interrupting an Electrical Current Circuit

(71) Applicant: Panasonic Industrial Devices Europe GmbH, Luneburg (DE)

(72) Inventor: Rastislav KONKOL, Bardowick (DE)

(73) Assignee: Panasonic Industrial Devices Europe GmbH, Luneburg (DE)

(21) Appl. No.: 16/772,515

(22) PCT Filed: Dec. 13, 2018
(86) PCT No.: PCT/EP2018/084765

§ 371 Date: Nov. 2, 2020

(30) Foreign Application Priority Data
Dec. 15, 2017 (DE) 10 2017 011 631.8

(51) Int. Cl. H01H 39/00; H01H 85/055; H01H 85/47

(52) U.S. Cl. CPC H01H 39/006; H01H 85/47; H01H 85/055

(57) ABSTRACT

The invention relates to a device for interrupting an electrical current circuit, more particularly a device of this kind that can safely perform a disconnection in a current range up to 100 kA. The device comprises a pyrotechnic switch (PTS) and a safety fuse, wherein the PTS and the safety fuse are connected in series and wherein the PTS can be actively triggered. The PTS is preferably triggered as a result of a current flowing in the current circuit only if the current measured in the current circuit has exceeded a particular value for a particular period of time (filtering time of the PTS).

The invention relates to a device for interrupting an electrical circuit, in particular such a device which can disconnect safely in a current range up to 100 kA.

One possible field of use for such a device (interrupting device) is electric vehicles and other battery applications. Particularly in the case where an electric vehicle is involved in an accident, it may be necessary to disconnect an electrical circuit rapidly and safely.

Pyrotechnic fuses are known which are driven actively for triggering. The use of pyrotechnic fuses in electric vehicles has already been proposed as well. However, it has been found that none of the known pyrotechnic fuses can disconnect with sufficient safety in the entire range of the voltages and/or currents that possibly occur in electromobility.

Therefore, it is an object of the invention to provide a device for interrupting an electrical circuit which achieves a disconnection with high safety even at high voltages and/or currents. The object is achieved by means of a device as claimed in patent claim 1. Further advantageous embodiments are the subject matter of the dependent claims or are described below.

Preferably, the pyrotechnic fuse element (PTS) is triggered on account of a current flowing in the electrical circuit only if the current measured in the electrical circuit has exceeded a specific value for a specific time duration (filtering time of the PTS). If the measured current exceeds a specific value, for example on account of an electric vehicle being struck by lightning, but this exceedance does not last for the specific time duration the PTS would not be triggered. This reduces the risk of the triggering being effected even though there is no situation prevailing in which an interruption of the electrical circuit is necessary or desired.

In terms of circuitry, such a delayed triggering can preferably be realized with the use of an optical link.

It is particularly advantageous if the PTS is not triggered until a further specific time duration (delay time of the PTS) has also elapsed after the end of the filtering time. During this delay time, energy can still be incorporated into the fusible link and dissipated. Preferably, the delay time is 1 to 2 ms.

The sum of the filtering time of the PTS and the delay time of the PTS is referred to hereinafter as the triggering time of the PTS.

It is particularly advantageous if the filtering time of the PTS and/or the delay time of the PTS vary automatically depending on the external temperature. This is because the external temperature can influence the time-current characteristic curve of the fusible link. This variation of the properties of the fusible link on account of a variation of the external temperature can be compensated for by an automatic variation of the triggering time of the PTS in the sense that the PTS is triggered correspondingly earlier or later. This makes it possible to ensure that the current on no account exceeds a specific value (for a longer time than the maximum triggering time).

It is particularly advantageous if a triggering of the PTS can also be initiated independently of the measured current. This makes it possible that the electrical circuit to be interrupted can be interrupted even at a point in time at which no or only a low current is flowing in the electrical circuit. There may be a need in the case of electric vehicles, for example, if a vehicle collision is detected which also results in the triggering of an airbag.

It has proved to be particularly advantageous if the filtering time of the PTS is at least 500 μs. Particularly advantageously, the filtering time is in the range of between 500 μs and 3 ms. The triggering time of the PTS is preferably in the range of between 500 μs and 30 ms. Preferably, the triggering time is chosen such that the critical energy contribution is not exceeded by the weakest element in the system at any operating point.

It is advantageous if the fusible link is chosen such that it can disconnect safely in a current range up to at least 100 kA in the temperature range of −40° C. to 125° C.

It is advantageous if the fusible link is chosen such that it can disconnect safely in a current range beginning at 4 kA within the triggering time of the PTS in a temperature range of −40° C. to 125° C.

Advantageously, the PTS is chosen such that it can disconnect in a current range of from 0 to at least the minimum current of the fusible link, wherein the minimum current of the fusible link is the weakest current for which the fusible link still disconnects within the triggering time.

In one preferred embodiment, the PTS comprises an explosive charge that is situated in a body.

In one preferred embodiment, the PTS is activatable by an electrical igniter.

Preferably, the PTS has a disconnecting claw in the chamber, which disconnecting claw divides the chamber into two separate and insulated spaces after the disconnection process. Preferably, the disconnecting claw is embodied in a solid fashion, such that it withstands a plasma fire for the required time. Preferably, the disconnecting claw consists of insulating material. Preferably, after the severing of the conductor, the disconnecting claw forms in its end position a part of a closed wall composed of insulating material. Preferably, the disconnecting claw is immersed in a chamber with extinguishing substance such as extinguishing sand, for example, after the disconnection and/or it is covered with an extinguishing substance from above after the disconnection.

In another particularly preferred embodiment, the PTS comprises a hollow cylinder, in which a piston is situated, below which a disconnecting claw is situated. The disconnecting claw is intended to sever the conductor to be disconnected that is arranged below it.

Preferably, a supply of an extinguishing substance, such as extinguishing sand, is situated in a chamber outside the cylinder, which extinguishing substance can move into a disconnecting chamber after the PTS has been triggered, in which disconnecting chamber the disconnecting claw is situated after the conductor has been severed, or which disconnecting chamber is situated above the disconnecting claw. Preferably, the residual pressure of the explosion of the explosive substance is used to accelerate the movement of the extinguishing substance into the disconnecting chamber.

Preferably, a counterpart to the disconnecting claw is situated below the conductor to be disconnected, the shape of said counterpart being complementary to that of the disconnecting claw.

Preferably, the PTS has a permanent magnet and also a magnetic field concentrator arranged parallel to the conductor to be disconnected. As a result, plasma sparks that possibly arise after the disconnection can be extinguished.

In one preferred embodiment, two opposite side walls of the PTS are formed by plates consisting substantially of iron.

In one advantageous embodiment, two opposite side walls of the PTS are formed by plates which are premagnetized, such that plasma sparks that possibly arise in the PTS after the disconnection can be extinguished with the aid of the magnetic field generated by them.

Preferably, a side wall of the PTS is are connected to an end of a conductor that is part of the electrical circuit.

Preferably, plasma sparks that possibly arise in the fusible link after a disconnection are extinguished with the aid of an extinguishing sand contained in the fusible link.

Preferably, the fusible link comprises at least one fusible conductor. In this case, the fusible conductor is preferably a metal strip comprising copper and silver.

Preferably, the fusible link comprises two substantially plate-type covers. In this case, at least one of the two plate-type covers preferably consists of iron. Preferably, one plate-type cover of the fusible link is connected to an end of a conductor that is part of the electrical circuit.

It is particularly advantageous if one of the plate-type covers of the fusible link is simultaneously one of the two premagnetized plates of the PTS.

It is particularly advantageous if the fusible link and the PTS are surrounded by a common insulation sheath.

It is particularly advantageous if the fusible link and the PTS are embodied in a tight fashion. It is particularly advantageous if the fusible link and the PTS have a common sheath. It is advantageous if the PTS can withstand high pressures. A pressure relief valve can be realized by weakening of the sheath.

The combination of PTS and fusible link enables a significantly smaller construction of the PTS in comparison with fuses consisting exclusively of a PTS. Furthermore, the combination also makes it possible for the losses that are typically caused by a fusible link to be kept low.

Preferably, the fusible link and the PTS are integrated in one component. As a result, the size, i.e. the required volume, of the device can be considerably reduced. Moreover, the undesired inductance can be reduced. Preferably, the integration in one component is effected in such a way that the integrated component can be cooled by a single cooling installation. The thermal management is simplified as a result.

The device according to the invention enables a safe disconnection in a voltage range up to at least 1000 V.

The invention is explained in greater detail with reference to the figures. In the figures:

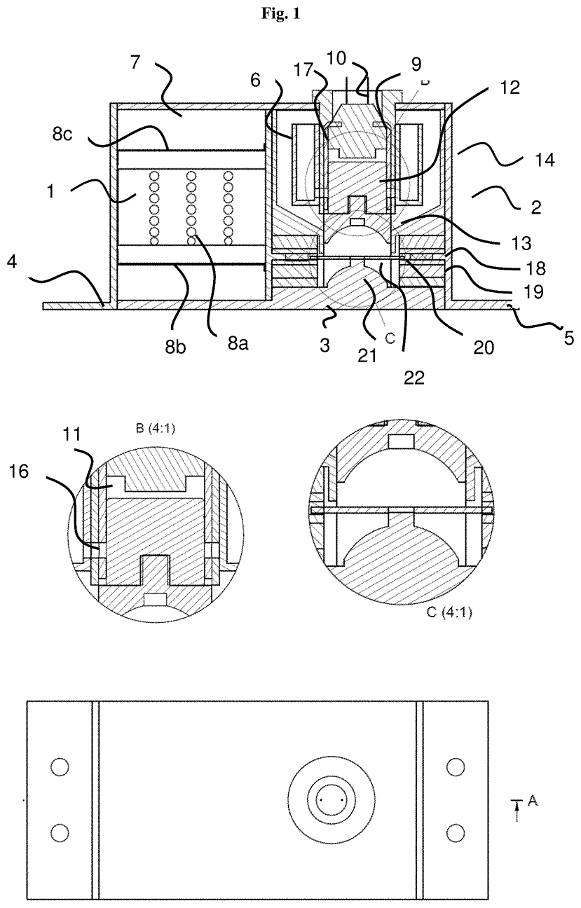

FIG. 1: shows an interrupting device according to the invention

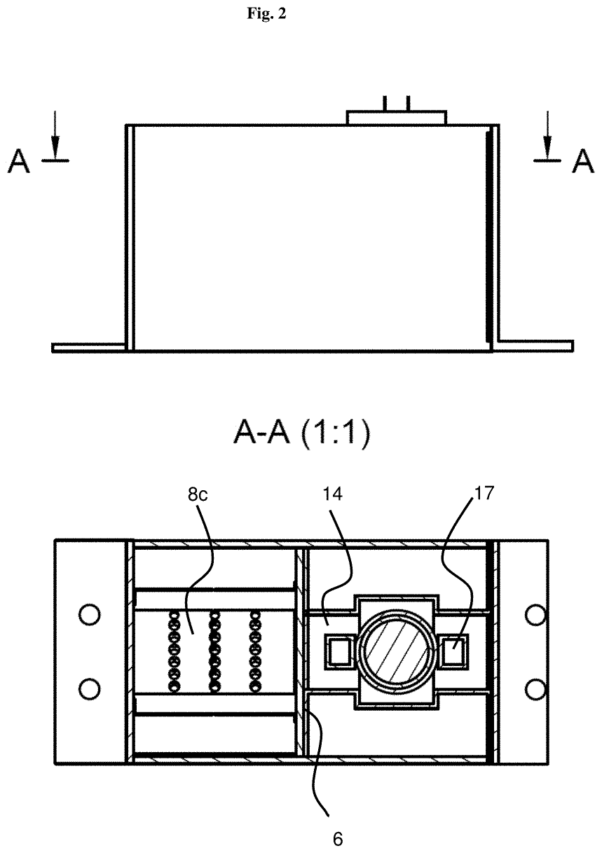

FIG. 2: shows an interrupting device according to the invention

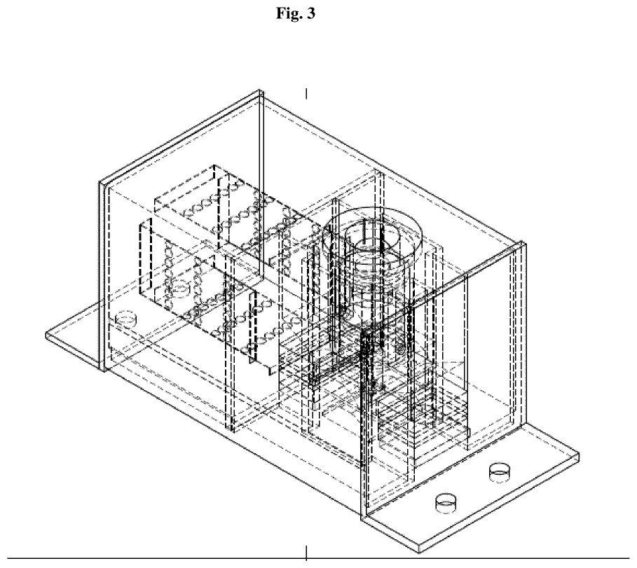

FIG. 3: shows an interrupting device according to the invention

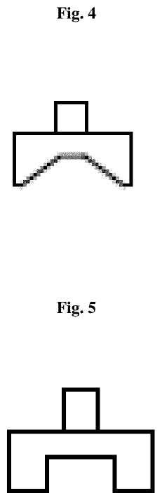

FIG. 4: shows one preferred embodiment of a disconnecting claw

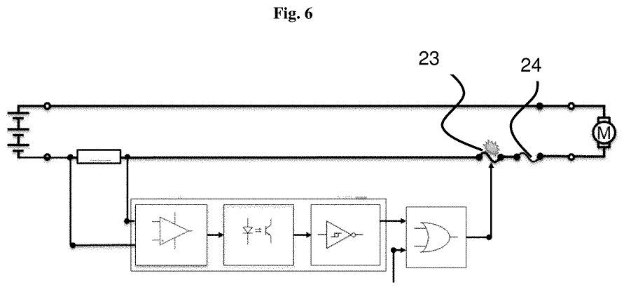

FIG. 5: shows one preferred embodiment of a disconnecting claw

FIG. 6: shows a circuit comprising an interrupting device according to the invention

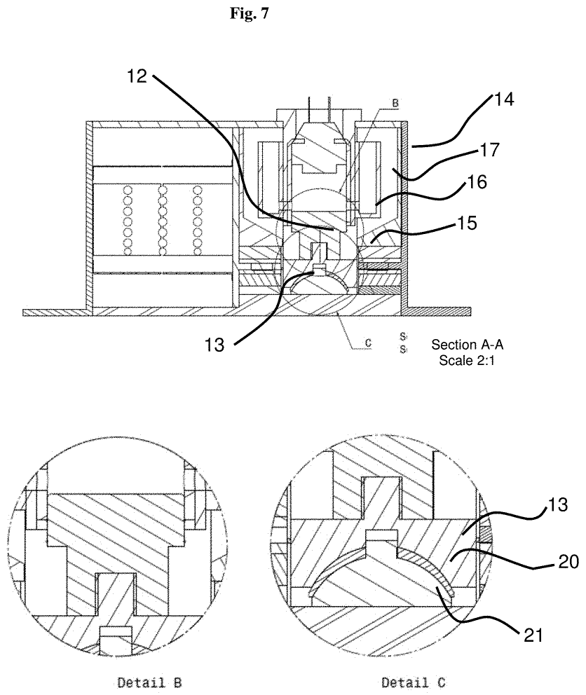

FIG. 7: shows an interrupting device according to the invention after the PTS has been triggered

FIG. 1 shows an interrupting device according to the invention in a vertical cross section and in plan view before the triggering of the pyrotechnic fuse element (PTS). The interrupting device is substantially parallelepipedal. The parallelepiped has, in particular, two end faces 1, 2 and a base face 3. In the plane of the base face 3, a rectangular metal plate 4 and 5 respectively extends outward from each end face.

The interrupting device comprises a fusible link and a pyrotechnic fuse element (PTS). One end wall 2 of the interrupting device is formed by a side wall of the PTS. The other end wall 1 is formed by a side wall of the fusible link. Both end walls 1, 2 are respectively connectable to an end of a conductor, for example composed of copper, that is part of the electrical circuit. One side wall 6 of the fusible link is simultaneously a side wall of the PTS. This common side wall 6 is a plate-type cover composed of iron.

The side walls of the interrupting device which are not end walls 1, 2 comprise an insulation sheath 7 having suitable thermal properties.

A plurality of strip-shaped fusible conductors 8a, 8b, 8c are situated between the common side wall 6 of the fusible link and the PTS and the opposite side wall 1 of the fusible link. The strip-shaped fusible conductors 8a, 8b, 8c lie partly in planes that are perpendicular to one another. The fusible conductors 8a, 8b, 8c have sections composed of copper and sections composed of silver. The sections of the fusible conductors which consist of silver have holes.

The PTS comprises a body 9 with an explosive charge situated therein. The PTS is activatable by an electrical igniter the contacts 10 of which are situated at the top side of the interrupting device.

The PTS comprises a hollow cylinder 11, in which a piston 12 is situated. A disconnecting claw 13 is situated below the piston. When the explosive charge explodes, the piston 12 and thus also the disconnecting claw 13 are pressed downward.

A supply of extinguishing sand (not shown in the drawing) is situated in a chamber 14 outside the cylinder 11. As long as the PTS has not triggered, the disconnecting claw 13, with its outer surfaces, closes an opening in the extinguishing sand supply chamber 14. FIG. 7 shows the interrupting device after the triggering of the PTS. When the piston 12 and the disconnecting claw 13 are pressed downward and reach their end position after the triggering of the PTS, the extinguishing sand supply chamber 14 is opened toward the disconnecting chamber 15 as a result. The extinguishing sand then moves into the disconnecting chamber 15. As a result of the piston 12 and the disconnecting claw 13 being pressed down, holes 16 are furthermore opened, through which pressure can escape into the extinguishing sand supply chamber 14 through a pressure diverting channel 17, as a result of which the extinguishing sand, which is sealed from above, is forced from the extinguishing sand supply chamber 14 into the disconnecting chamber 15. The residual pressure of the explosion is thus used to bring about or to accelerate the movement of the extinguishing substance, which is intended to smother a plasma fire that possibly arises, into the disconnecting chamber 15.

The PTS has a permanent magnet 18 and also a magnetic field concentrator 19 composed of cold-rolled iron sheets or soft iron wires, which is arranged parallel to the conductor 20 that is intended to be severed. Plasma sparks that possibly arise in the PTS after the disconnection are thereby intended to be able to be extinguished.

The counterpart 21 to the disconnecting claw 13 is situated below the conductor 20 to be severed by the disconnecting claw 13, the shape of said counterpart being complementary to that of the disconnecting claw. The counterpart 21 is likewise composed of insulating material. The counterpart has the shape of a dome with a cylinder 22 seated on its apex, the horizontal end face of said cylinder being arranged below the conductor 20.

When the disconnecting claw 13 is pressed downward upon the triggering of the PTS, it severs the conductor 20 at two points. That piece of the conductor 20 which is cut out in this way is fixed by virtue of the fact that it is clamped in between the cylinder 22 at the apex of the counterpart and the disconnecting claw, and is deformed by the shape of the counterpart 21 and/or of the disconnecting claw 13, such that the insulation clearance becomes maximal

FIG. 2 shows the interrupting device according to the invention in accordance with FIG. 1 in a side view and horizontally cut away from above.

FIG. 3 shows an interrupting device according to the invention in a semi-transparent illustration.

FIGS. 4 and 5 show preferred embodiments of the disconnecting claw 13.

FIG. 6 shows a circuit comprising an interrupting device according to the invention. The PTS 23 and the fusible link 24 are connected in series. The PTS 23 is triggered on account of a current flowing in the electrical circuit only if the current measured in the electrical circuit has exceeded a specific value for a specific time duration (filtering time of the PTS). The triggering is not effected until additionally a specific further time duration (delay time of the PTS) has also elapsed. However, the triggering can also be initiated independently of the measured current.

1.-33. (canceled)

34. A device for interrupting an electrical circuit, comprising
a pyrotechnic fuse element (PTS); and
a fusible link, wherein the PTS and the fusible link are connected in series and wherein the PTS can be actively triggered.

35. The device as claimed in claim 34, wherein the PTS is triggered on account of a current flowing in the electrical circuit only if the current measured in the electrical circuit has exceeded a specific value for a specific time duration (filtering time of the PTS).

36. The device as claimed in claim 35, wherein the PTS is not triggered until a further specific time duration (delay time of the PTS) has also elapsed after the end of the filtering time.

37. The device as claimed in claim 35, wherein the filtering time of the PTS and/or the delay time of the PTS vary automatically depending on the external temperature.

38. The device as claimed in claim 35, wherein the PTS can also be triggering independently of the measured current.

39. The device as claimed in claim 35, wherein the filtering time of the PTS is at least 500 μs.

40. The device as claimed in claim 35, wherein the filtering time of the PTS is in the range of between 500 μs and 3 ms.

41. The device as claimed in claim 35, wherein the sum of the filtering time of the PTS and the delay time of the PTS (triggering time of the PTS) is in the range of between 0.5 ms and 30 ms.

42. The device as claimed in claim 35, wherein fusible link (23) can disconnect safely in a current range up to at least 100 kA in the temperature range of −40° C. to 125° C. within the triggering time of the PTS.

43. The device as claimed in claim 35, wherein the fusible link can disconnect safely in a current range beginning at 4 kA within the triggering time of the PTS in a temperature range of −40° C. to 125° C.

44. The device as claimed in claim 35, wherein the PTS can disconnect in a current range of from 0 to at least the minimum current of the fusible link, wherein the minimum current of the fusible link is the weakest current for which the fusible link still disconnects within the triggering time of the PTS.

45. The device as claimed in claim 34, wherein the PTS comprises an explosive charge in a body.

46. The device as claimed in claim 34, wherein the PTS is activatable by an electrical igniter.

47. The device as claimed in claim 34, wherein the PTS comprises a hollow cylinder in which a piston is situated, below which is situated a disconnecting claw, below which is situated a conductor that when severed interrupts the electrical circuit.

48. The device as claimed in claim 47, wherein the disconnecting claw is embodied in a solid fashion to withstand a plasma fire for a required time.

49. The device as claimed in claim 47, wherein a supply of an extinguishing substance is situated in a chamber outside the cylinder, which extinguishing substance can move into a disconnecting chamber after the PTS has been triggered.

50. The device as claimed in claim 49, wherein residual pressure of the explosion of the explosive charge accelerates movement of the extinguishing substance into the disconnecting chamber.

51. The device as claimed in claim 47, wherein a counterpart to the disconnecting claw is situated below the conductor, said counterpart having a shape complementary to that of the disconnecting claw.

52. The device as claimed in claim 34, wherein the PTS has a permanent magnet and a magnetic field concentrator arranged parallel to the conductor.

53. The device as claimed in claim 34, wherein two opposite side walls of the PTS are formed by iron plates.

54. The device as claimed in claim 53, wherein the iron plates are premagnetized, whereby a magnetic field from the iron plates can extinguish plasma sparks arising in the PTS after interruption of the electrical circuit.

55. The device as claimed in claim 34, wherein the PTS has a disconnecting claw configured to sever the conductor after the PTS has been triggered and which is immersed in a chamber with extinguishing substance after the disconnection.

56. The device as claimed in claim 34, wherein two side walls of the PTS are each connected to opposite ends of the conductor.

57. The device as claimed in claim 34, wherein plasma sparks that possibly arise in the fusible link after a disconnection are extinguished with the aid of an extinguishing sand contained in the fusible link.

58. The device as claimed in claim 34, wherein the fusible link comprises at least one fusible conductor.

59. The device as claimed in claim 58, wherein the fusible conductor is a metal strip comprising copper and silver.

60. The device as claimed in claim 34, wherein the fusible link comprises two substantially plate-type covers.

61. The device as claimed in claim 60, wherein at least one of the two plate-type covers comprises iron.

62. The device as claimed in claim 60, wherein one plate-type cover of the fusible link is connected to an end of a conductor that is part of the electrical circuit.

63. The device as claimed in claim 60, wherein one of the plate-type covers of the fusible link is simultaneously one of the two premagnetized plates of the PTS.

64. The device as claimed in claim 34, wherein the fusible link and the PTS are surrounded by a common insulation sheath.

65. The device as claimed in claim 34, wherein the fusible link and the PTS are integrated in one component.

66. The device as claimed in claim 65, wherein the integrated component is configured to be cooled by a cooling installation.
